(19) United States
(12) Patent Application Publication
(10) Pub. No.: US 2012/0305777 A1
(43) Pub. Date: Dec. 6, 2012

(54) RADIATION IMAGE PICKUP DEVICE AND RADIATION IMAGE PICKUP DISPLAY SYSTEM INCLUDING THE SAME

(75) Inventors: Yasuhiro Yamada, Kanagawa (JP); Tsutomu Tanaka, Kanagawa (JP)

(73) Assignee: Sony Corporation, Tokyo (JP)

(21) Appl. No.: 13/460,163

(22) Filed: Apr. 30, 2012

(30) Foreign Application Priority Data
May 30, 2011 (JP) 2011-119918

(51) Int. Cl. G01T 1/20; G01T 1/24

(52) U.S. Cl. 250/361 R

(57) ABSTRACT

A radiation image pickup device includes: a sensor substrate including a photoelectric conversion element; a non-ionic layer provided on a part of the sensor substrate; and a wavelength converting member provided on the non-ionic layer, and converting a wavelength of a radiation into a wavelength in a sensitivity range of the photoelectric conversion element.

### BACKGROUND

The present disclosure relates to a radiation image pickup device which, for example, is suitable for X-ray photography for a medical care or nondestructive inspection, and a radiation image pickup display system including the same.

In recent years, a technique using either a Charge Coupled Device (CCD) image sensor or a Complementary Metal Oxide Semiconductor (CMOS) image sensor is a mainstream as a technique for acquiring an image in the form of an electrical signal (an image pickup technique by using photoelectric conversion). An image capturing area in such an image sensor is limited by a size of a crystal substrate (silicon wafer). Recently, however, for example, in a medical care field in which X-ray photography is carried out, or the like, an increased area for the image capturing area has been required. In addition, a demand for a moving image performance is being increased.

A radiation image pickup device for obtaining an image based on a radiation in the form of an electrical signal without through a radiation photograph film has been developed as an image pickup device, requiring an increased area, such as an X-ray image pickup device for capturing an image of a bust of the human body. The radiation image pickup device is such that a wavelength converting layer (made of a phosphor or a scintillator) is provided on a circuit substrate including a photoelectric conversion element such as a photodiode, and a Thin Film Transistor (TFT). In such a radiation image pickup device, after a radiation made incident thereto has been converted into a visible light, the resulting visible light is made incident to the photoelectric conversion element, and an electrical signal obtained based on a quantity of received visible light in the photoelectric conversion element is read out by the circuit including the TFT.

Here, a technique for forming the wavelength converting layer includes: a first technique; and a second technique. In this case, with the first technique, a scintillator material is tightly formed on the substrate, as described above, including the photoelectric conversion element and the transistor (hereinafter referred to as “the sensor substrate”) by utilizing an evaporation method. Also, with the second technique, a wavelength converting plate which is formed separately from the sensor substrate is disposed on the sensor substrate. For example, Japanese Patent Laid-Open No. 2009-300213 proposes a scintillator plate in which a scintillator layer formed on a substrate is covered with a protective film.

### SUMMARY

However, when the scintillator plate as described in Japanese Patent Laid-Open No. 2009-300213 is used, dew condensation is generated between the sensor substrate and the scintillator, which results in an increase in a dark current. Since the generation of the dark current causes reduction in an image quality, an improvement therein is desired.

The present disclosure has been made in order to solve the problems described above, and it is therefore desirable to provide a radiation image pickup device in which reduction in an image quality due to dew condensation can be suppressed, and a radiation image pickup display system including the same.

In order to attain the desire described above, according to an embodiment of the present disclosure, there is provided a radiation image pickup device including: a sensor substrate including a photoelectric conversion element; a non-ionic layer provided on a part of the sensor substrate; and a wavelength converting member provided on the non-ionic layer, and converting a wavelength of a radiation into a wavelength in a sensitivity range of the photoelectric conversion element.

According to another embodiment of the present disclosure, there is provided a radiation image pickup display system including: an image pickup device (a radiation image pickup device according to an embodiment of the present disclosure) acquiring an image based on a radiation; and a display device displaying thereon the image acquired from the image pickup device, the image pickup device including: a sensor substrate including a photoelectric conversion element; a non-ionic layer provided a part on the sensor substrate; and a wavelength converting member provided on the non-ionic layer, and converting a wavelength of a radiation into a wavelength in a sensitivity range of the photoelectric conversion element.

In the radiation image pickup device of the embodiment, and the radiation image pickup display system of another embodiment, after the incident radiation has been transmitted through the wavelength converting member, the resulting radiation is received by the photoelectric conversion element, whereby an electrical signal (image information) corresponding to a quantity of received radiation is obtained. Here, when the dew condensation causes water to collect between the wavelength converting member and the sensor substrate, the coupling of the ion components contained in the water, and the photoelectric conversion element (the electrode(s) of the photoelectric conversion element, or the like) is caused to increase the dark current in some cases. However, the providing of the non-ionic layer suppresses such coupling and thus the dark current is hard to generate.

As set forth hereinafter, according to an embodiment of the present disclosure, since the non-ionic layer is provided between the wavelength converting member and the sensor substrate, even when the dew condensation is generated between the wavelength converting member and the sensor substrate, it is possible to suppress the increase in the dark current caused by the generation of the dew condensation. Therefore, it is possible to suppress the reduction of the image quality due to the generation of the dew condensation.

### BRIEF DESCRIPTION OF THE DRAWINGS

FIG. 1 is a partial cross sectional view showing a schematic structure of a radiation image pickup device according to a first embodiment of the present disclosure;

FIG. 2 is a functional block diagram showing an entire configuration of a sensor substrate in the radiation image pickup device of the first embodiment shown in FIG. 1;

FIG. 3 is a circuit diagram showing a configuration of a pixel circuit (complying with an active drive system) in a unit pixel shown in FIG. 2;

FIGS. 4A to 4L are respectively cross sectional views explaining a method of manufacturing a photodiode in the radiation image pickup device of the first embodiment shown in FIG. 1 in the order of processes;

FIG. 5 is a cross sectional view explaining an operation of a radiation image pickup device according to a comparative example for the first embodiment of the present disclosure;

FIG. 6 is a partial cross sectional view showing a schematic structure of a radiation image pickup according to Modified Change 1 of the first embodiment of the present disclosure;

FIG. 7 is a partial cross sectional view showing a schematic structure of a radiation image pickup according to Modified Change 2 of the first embodiment of the present disclosure;

FIG. 8 is a circuit diagram showing a configuration of a pixel circuit (complying with a passive drive system) in a radiation image pickup device according to Modified Change 3 of the first embodiment of the present disclosure;

FIG. 9 is a partial cross sectional view showing a schematic structure of the radiation image pickup device utilizing the passive drive system;

FIG. 10 is a cross sectional view showing a schematic structure of a radiation image pickup according to Modified Change 4 of the first embodiment of the present disclosure; and

FIG. 11 is a schematic block diagram showing an entire configuration of a radiation image pickup display system according to a second embodiment of the present disclosure.

### DETAILED DESCRIPTION OF THE PREFERRED EMBODIMENTS

Embodiments of the present disclosure will be described in detail hereinafter with reference to the accompanying drawings. It is noted that the description will be given below in accordance with the following order:

1. First Embodiment (a radiation image pickup device: the case where a highly planarizing film (non-ionic layer) is provided between a sensor substrate and a scintillator plate);

2. Modified Change 1 (the case where a non-ionic layer is provided on a part on the sensor substrate);

3. Modified Change 2 (the case where both of the sensor substrate and a scintillator plate are encapsulated with a moistureproof layer);

4. Modified Change 3 (the case of a pixel circuit complying with a passive drive system);

5. Modified Change 4 (the case where a p-type semiconductor layer of a photodiode is made of amorphous silicon); and

6. Second Embodiment (a radiation image pickup display system).

### 1. First Embodiment

### [Structure]

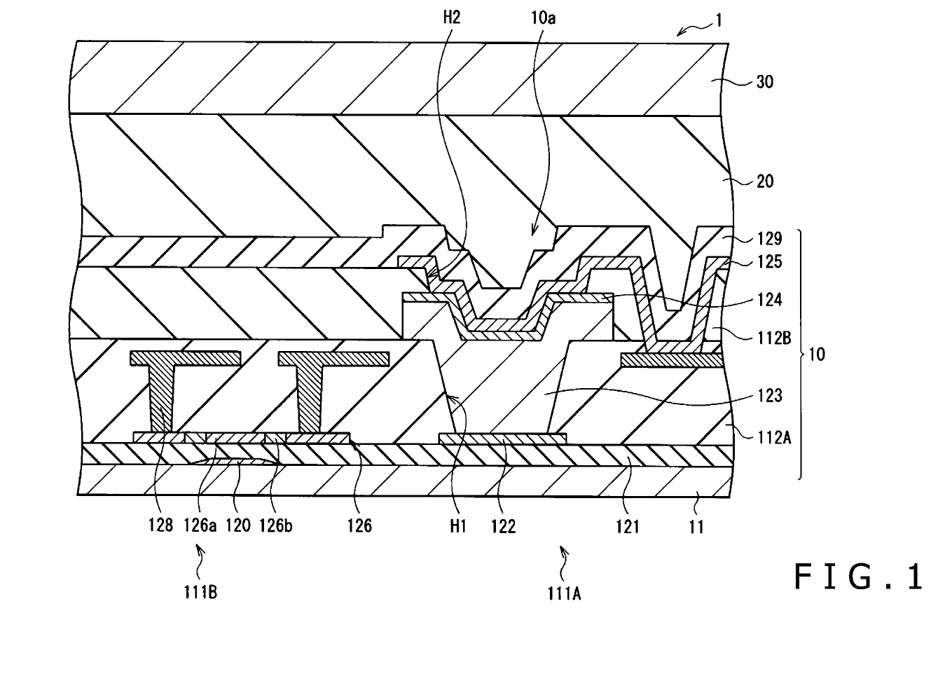

FIG. 1 is a partial cross sectional view showing an entire structure of a radiation image pickup device (a radiation image pickup device 1) according to a first embodiment of the present disclosure. The radiation image pickup device 1 wavelength-converts a radiation typified by an α-ray, a β-ray, a γ-ray or an X-ray, receives the resulting radiation, and reads out image information based on the resulting radiation. The radiation image pickup device 1 is suitably used as an X-ray image pickup device for a nondestructive inspection such as a baggage inspection, including a medical care.

In the radiation image pickup device 1, a scintillator plate (scintillator panel) 30 is disposed above a sensor substrate 10 so as to face the sensor substrate 10. The sensor substrate 10 and the scintillator plate 30 are manufactured as separate modules, respectively. In the radiation image pickup device 1 of the first embodiment, a highly planarizing film 20 (a non-ionic layer) is provided between the sensor substrate 10 and the scintillator plate 30. It is noted that the scintillator plate 30 corresponds to a concrete example of “a waveform converting member” in the present disclosure.

### [Sensor Substrate 10]

The sensor substrate 10 includes plural pixels. Thus, a pixel circuit (a pixel circuit 12a which will be described later) including a photodiode 111A (photoelectric conversion element) and a transistor 111B is formed on a surface of a substrate 11. In the radiation image pickup device 1 of the first embodiment, the photodiode 111A and the transistor 111B are disposed in parallel relation to each other on the substrate 11 made of a glass or the like, and a part thereof (that is, a gate insulating film 121, a first interlayer insulating film 112A, and a second interlayer insulating film 112B which will be all described later in this case) becomes a mutually common layer.

### (Photodiode 111A)

The photodiode 111A is a photoelectric conversion element for generating electric charges (optical electric charges) having a quantity of electric charges corresponding to a quantity of incident light (quantity of received light) to accumulate the electric charges thus generated inside thereof. For example, the photodiode 111A is composed of a Positive Intrinsic Negative (PIN) photodiode. In the photodiode 111A, a sensitivity range thereof, for example, is set to a visible range (a wavelength range of a received light is the visible range). The photodiode 111A, for example, has a p-type semiconductor layer 122 in a selective area on the substrate 11 through the gate insulating film 121. The first insulating film 112A which has a contact hole (through hole) H1 facing the p-type semiconductor layer 122 is provided on the substrate 11 (specifically, on the gate insulating film 121). In the contact hole H1 of the first interlayer insulating film 112A, an i-type semiconductor layer 123 is provided on the p-type semiconductor layer 122. Also, an n-type semiconductor layer 124 is formed on the i-type semiconductor layer 123. An upper electrode 125 is connected to the n-type semiconductor layer 124 through a contact hole H2 formed on the second interlayer insulating film 112B. It is noted that although an example is given in which the p-type semiconductor layer 122 is provided on the substrate 11 side (lower portion side), and the n-type semiconductor layer 124 is provided on the upper portion side, a structure reverse to this structure, that is, a structure in which the n-type semiconductor layer 124 is provided on the substrate 11 side (lower portion side), and the p-type semiconductor layer 122 is provided on the upper portion side may also be adopted.

The gate insulating film 121, for example, is provided as the layer common to the photodiode 111A and the transistor 111B. Thus, the gate insulating film 121, for example, is composed of either a single layer film composed of one kind of film of a silicon oxide (SiO₂) film, a silicon oxynitride (SiON), and a silicon nitride (SiN) film, or a lamination film composed of two or more kinds of films of these films.

The p-type semiconductor layer 122, for example, is a p⁺-type region which is obtained by doping either polycrystalline silicon (poly silicon) or microcrystalline silicon with, for example, boron (B). A thickness of the p-type semiconductor layer 122, for example, is set in the range of 40 to 50 nm. The p-type semiconductor layer 122, for example, functions as a lower electrode for reading-out of the signal electric charges, and is connected to an accumulation node N which will be described later (the p-type semiconductor layer 122 serves as the accumulation node N as well).

Each of the first interlayer insulating film 112A and the second interlayer insulating film 112B, for example, is formed by laminating insulating films such as a silicon oxide film and a silicon nitride film one upon another. Also, each of the first interlayer insulating film 112A and the second interlayer insulating film 112B is formed as the layer common to each of the photodiode 111A and the transistor 111B.

The i-type semiconductor layer 123 is a semiconductor layer whose conductivity is lower than that of each of the p-type semiconductor layer 122 and the n-type semiconductor layer 124, for example, a non-doped intrinsic semiconductor layer and, for example, is made of amorphous silicon. Although a thickness of the i-type semiconductor layer 123, for example, is set in the range of 400 to 1,000 nm, an optical sensitivity can be increased as the thickness of the i-type semiconductor layer 123 is larger. The n-type semiconductor layer 124, for example, is made of amorphous silicon and thus forms an n⁺-type region. A thickness of the n-type semiconductor layer 124, for example, is set in the range of 10 to 50 nm.

The upper electrode 125, for example, is an electrode through which a reference electric potential for the photoelectric conversion is supplied, and is connected to a power source wiring (a terminal 133 which will be described later) for supply of the reference electric potential. The upper electrode 125, for example, is composed of a transparent conductive film, for example, made of an Indium Tin Oxide (ITO) or the like.

With regard to formation of the photodiode 111A, the p-type semiconductor layer 122, the i-type semiconductor layer 123, and the n-type semiconductor layer 124 are laminated in this order in an area corresponding to each of the contact holes H1 and H2 which are provided in the first interlayer insulating film 112A and the second interlayer insulating film 112B, respectively. For this reason, in a surface on the light incidence side of the sensor substrate 10, for example, a subduction (a dent 10a) due to the provision of the contact holes H1 and H2 is caused so as to correspond to the formation area of the photodiode 111A. That is to say, the surface on the light incidence side of the sensor substrate 10 becomes a uneven surface.

### (Transistor 111B)

The transistor 111B, for example, is a Field-Effect Transistor (FET). A gate electrode 120, for example, made of Ti, Al, Mo, W, Cr or the like is formed on the substrate 11 and the gate insulating film 121 is formed so as to cover the gate electrode 120. A semiconductor layer 126 is formed on a selective area of the gate insulating film 121. Also, the semiconductor layer 126 includes a channel region 126a, and Lightly Doped Drains (LDDs) 126b. The semiconductor layer 126, for example, is made of polycrystalline silicon, microcrystalline silicon or amorphous silicon and preferably is made of a Low-Temperature Poly Silicon (LTPS). Or, the semiconductor layer 126 may also be made of an oxide semiconductor such as an indium gallium zinc oxide (InGaZnO) or a zinc oxide (ZnO). A wiring layer 128 (either a source electrode or a drain electrode) made of Ti, Al, Mo, W, Cr or the like and connected to a signal line for reading-out and various kinds of wirings is formed in the first interlayer insulating film 112A provided so as to cover such a semiconductor layer 126. It is noted that the transistor 111B corresponds to any one of three transistors Tr1, Tr2, and Tr3 which will be all described later.

A protective film 129 is formed so as to cover the photodiode 111A and the transistor 111B. The protective film 129, for example, is composed of an insulating film made of a silicon oxide, a silicon nitride or the like, and a thickness thereof, for example, is set to 175 nm.

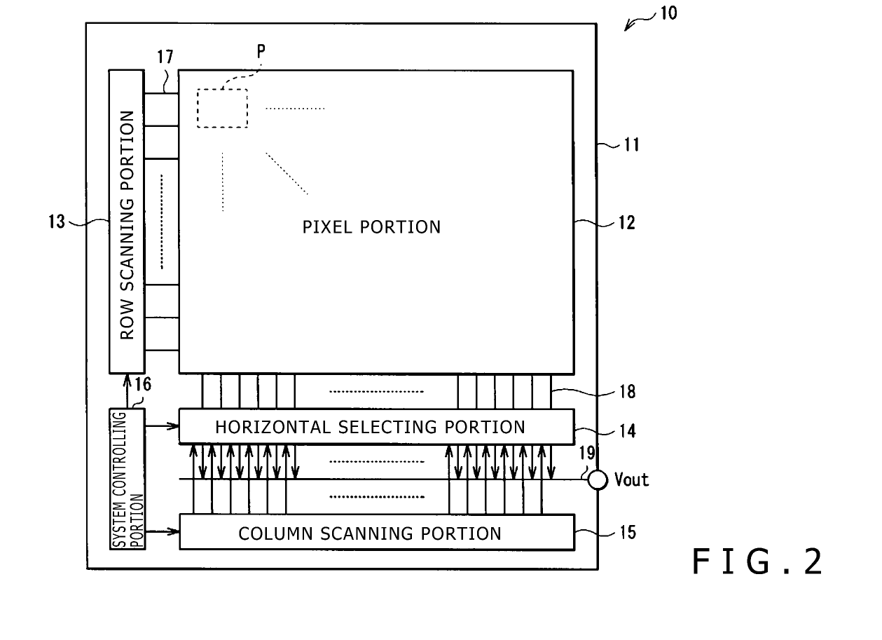

FIG. 2 is a functional block diagram showing an entire configuration of the sensor substrate 10 as described above. The sensor substrate 10 includes a pixel portion 12 serving as an image pickup area, and includes a peripheral circuit (drive circuit), for example, composed of a row scanning portion 13, a horizontal selecting portion 14, a column scanning portion 15, and a system controlling portion 16 in a peripheral area of the pixel portion 12.

The pixel portion 12 includes unit pixels P (hereinafter simply referred to as “pixels” in some cases) which, for example, are two-dimensionally disposed in a matrix. Each of the unit pixels P includes the photodiode 111A and the transistor 111B which have been described above. In an unit pixel P, for example, a pixel driving line 17 (specifically, a row selecting line and a reset controlling line) is wired every pixel row, and a vertical signal line 18 is wired every pixel column. The pixel driving line 17 is used to transmit a drive signal in accordance with which signals are read out from corresponding ones of the pixels P. One ends of the pixel driving lines 17 are connected to output ends corresponding to the rows of the row scanning portion 13.

### (Peripheral Circuit)

The row scanning portion 13 is a pixel driving portion which is composed of a shift register, an address decoder, and the like and, for example, drives the pixels P of the pixel portion 12 in rows. Signals outputted from the pixels P belonging to the pixel row which is selected and scanned by the row scanning portion 13 are supplied to the horizontal selecting portion 14 through vertical signal lines 18, correspondingly. The horizontal selecting portion 14 is composed of an amplifier, a horizontal selecting switch, and the like which are provided for each vertical signal line 18.

The column scanning portion 15 is composed of a shift register, an address decoder, and the like, and operates to drive the horizontal selecting switches of the horizontal selecting portion 14 one after another while it scans the horizontal selecting switches of the horizontal selecting portion 14. In accordance with the selection scanning by the column scanning portion 15, the signals, from the pixels P, which are transmitted through the respective vertical signal lines 18 are outputted to a horizontal signal line 19 one after another to be transmitted to the outside of the substrate 11 through the horizontal signal line 19 concerned.

The circuit portion composed of the row scanning portion 13, the horizontal selecting portion 14, the column scanning portion 15, and the horizontal signal line 19 either may be formed directly on the substrate 11 or may be one which is disposed in an external circuit IC. In addition, such a circuit portion may also be formed on another substrate which is connected to the substrate 11 through a cable or the like.

The system controlling portion 16 receives a clock signal which is supplied thereto from the outside of the substrate 11, data which is used to command an operation mode, and the like, and outputs data such as internal information of the radiation image pickup device 1. The system controlling portion 16 further includes a timing generator for generating various kinds of timing signals. Thus, the system controlling portion 16 carries out drive control for the peripheral circuits such as the row scanning portion 13, the horizontal selecting portion 14, and the column scanning portion 15 in accordance with the various kinds of timing signals generated by the timing generator.

### (Pixel Circuit)

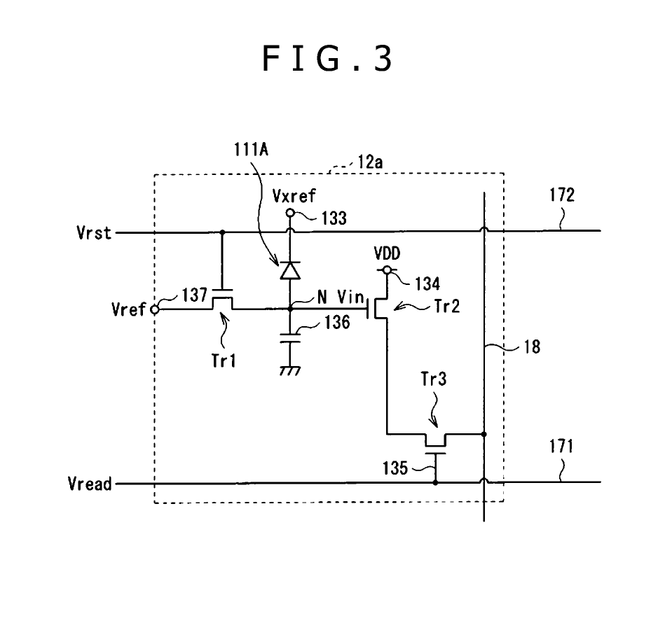

FIG. 3 is a circuit diagram showing a configuration of a pixel circuit (the pixel circuit 12a). The pixel circuit 12a includes the photodiode 111A, the transistors Tr1, Tr2, and Tr3 (any one of the transistors Tr1, Tr2, and Tr3 corresponds to the transistor 111B described above), the vertical signal line 18 described above, and a row selecting line 171 and a reset control line 172 both serving as the pixel driving line 17.

A reference electric potential Vxref is supplied to one end of the photodiode 111A, for example, through the terminal 133, and the other end of the photodiode 111A is connected to an accumulation node N. A capacitance component 136 exists in the accumulation node N. Thus, the signal electric charges generated in the photodiode 111A are accumulated in the accumulation node N. It is noted that a configuration may also be adopted such that the photodiode 111A is connected between the accumulation node N and the ground (GND).

The transistor Tr1 is a reset transistor and is connected between a terminal 137 to which a reference electric potential Vref is supplied, and the accumulation node N. The transistor Tr1 is turned ON in response to a reset signal Vrst, thereby resetting the electric potential at the accumulation node N to the reference electric potential Vref. The transistor Tr2 is a read transistor. Thus, a gate terminal of the transistor Tr2 is connected to the accumulation node N, and a terminal 134 on a side of a drain terminal of the transistor Tr2 is connected to a power source VDD. The transistor Tr2 receives the signal electric charges generated in the photodiode 111A at the gate terminal thereof, and outputs a signal voltage corresponding to the signal electric charges thus received. Also, the transistor Tr3 is a column selection transistor, and is connected between a source terminal of the transistor Tr2, and the vertical signal line 18. The transistor Tr3 is turned ON in response to a column scanning signal Vread, thereby outputting a signal outputted from the transistor Tr2 to the vertical signal line 18. It is noted that a configuration can also be adopted such that the transistor Tr3 is connected between the drain terminal of the transistor Tr2, and the power source VDD.

### [Scintillator Plate 30]

The scintillator plate 30, as described above, is manufactured as the module separate from the sensor substrate 10. The scintillator plate 30 is a flat plate-like (plate-like) wavelength converting member. For example, with regard to a structure of the scintillator plate 30, a scintillator layer (not shown) is provided on a transparent substrate made of a glass or the like. A protective film having a moistureproof property either may be formed on the scintillator layer or may be provided so as to cover the whole of both of the scintillator layer and the transparent substrate.

A scintillator (phosphor) for converting a radiation (X-ray) into a visible light, for example, is used in such a scintillator plate 30. Such a phosphor, for example, includes materials such as a compound (CsI; Tl) obtained by adding thallium (Tl) to cesium iodide (CsI), a compound obtained by adding terbium (Tb) to gadolinium oxidized sulfer (Gd₂O₂S), BaFX (X is Cl, Br, I or the like), and the like. A thickness of the scintillator layer is preferably set in the range of 100 to 600 μm. When CsI; Tl, for example, is used as the material for the scintillator layer, the thickness of the scintillator layer, for example, is 600 μm. It is noted that the scintillator layer can be deposited on the transparent substrate by, for example, utilizing a vacuum evaporation method. Although in this case, the scintillator plate as described above is exemplified, all it takes is the wavelength converting member which can wavelength-convert the radiation into the light having the sensitivity range of the photodiode 111A, and thus the embodiment of the present disclosure is especially by no means limited to the materials described above.

### [Highly Planarizing Film 20]

The highly planarizing film 20 is provided between the sensor substrate 10 as described above, and the scintillator plate 30. Although as described above, the surface of the sensor substrate 10 has the dent 10a so as to correspond to the formation area of the photodiode 111A, the highly planarizing film 20 is provided on the sensor substrate 10 so as to be filled in at least such a dent 10a. In this case, the highly planarizing film 20 is provided on the sensor substrate 10 so as to have a larger thickness than that of each of the layers (the p-type semiconductor layer 122, the i-type semiconductor layer 123, and the n-type semiconductor layer 124) of the photodiodes 111A, and has a part for planarizing the uneven shape formed on the surface of the sensor substrate 10. In other words, the highly planarizing film 20 has a uneven shape following the uneven shape of the sensor substrate 10 on the sensor substrate 10 side, while the surface of the highly planarizing film 20 on the scintillator plate 30 side is flat.

The highly planarizing film 20 is made of a material which has a non-ionic property (which does not generate the ions through electrolysis), and which, for example, has the transparency for the visible light. In addition, preferably, the highly planarizing film 20 is made of a material which is excellent in flatness as with the first embodiment. Such a material includes a silicon resin (silicone), an acrylic resin, a parylene resin, and the like. In this case, preferably, the highly planarizing film 20 is made of the silicon resin. A thickness of the highly planarizing film 20 is preferably set sufficiently larger than that of each of the layers of the photodiode 111A and for example, is set equal to or larger than 3 μm.

Although such a highly planarizing film 20 is provided so as to face the scintillator plate 30, an upper surface of the highly planarizing film 20 and a lower surface of the scintillator plate 30 does not contact each other (the scintillator plate 30 and the highly planarizing film 20 are provided so as to sandwich a small air layer between them, and thus are not tightly adhered to each other). However, the highly planarizing film 20 and the scintillator plate 30 may be bonded to each other outside the pixel portion 12 (in the peripheral area) by using a sealing material.

### [Manufacturing Method]

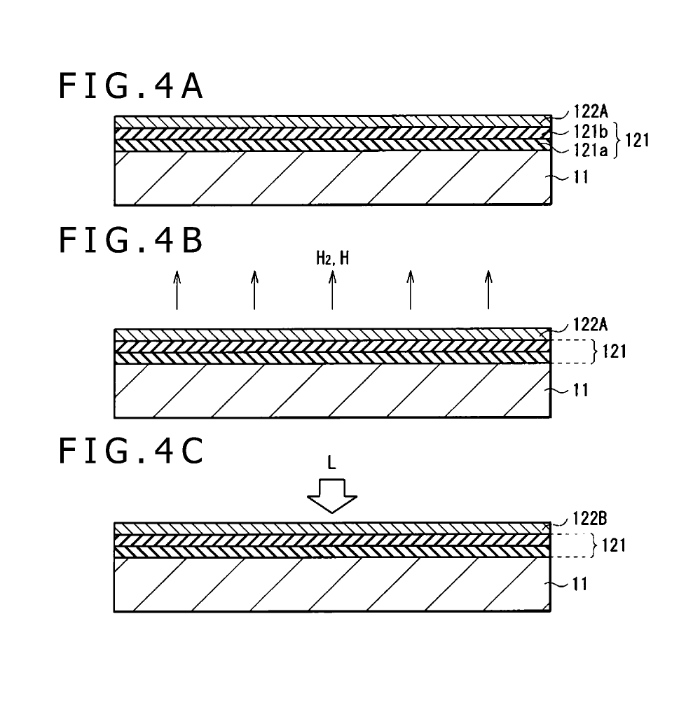

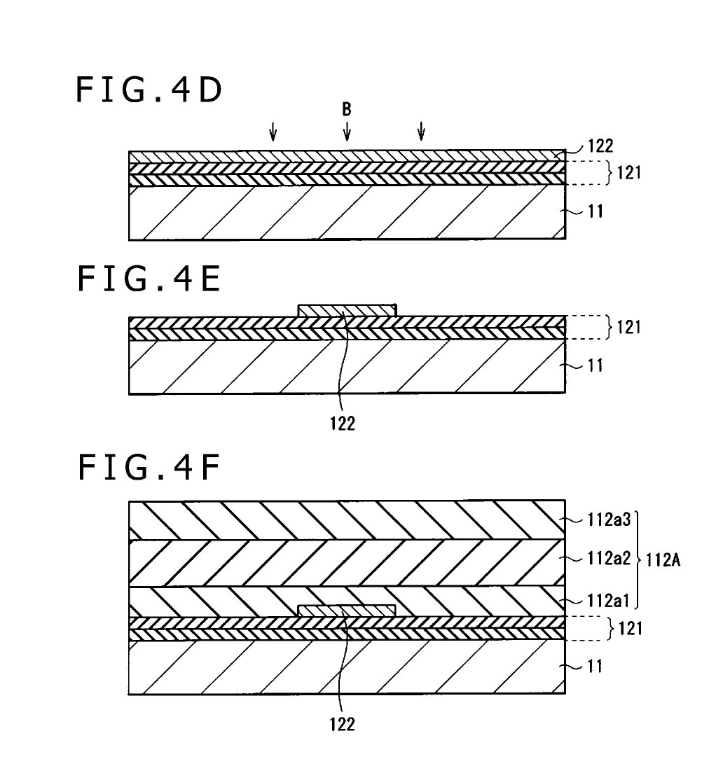

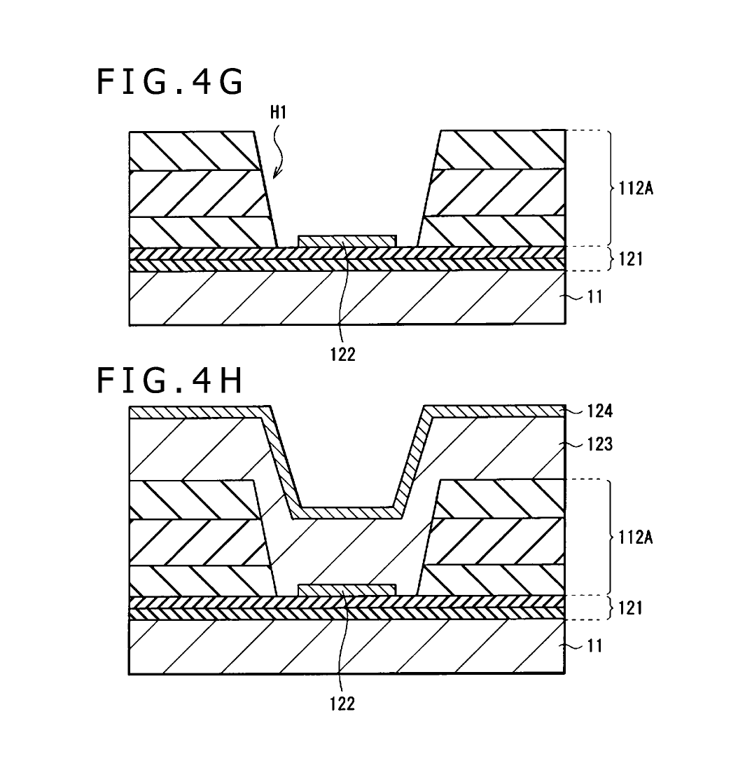

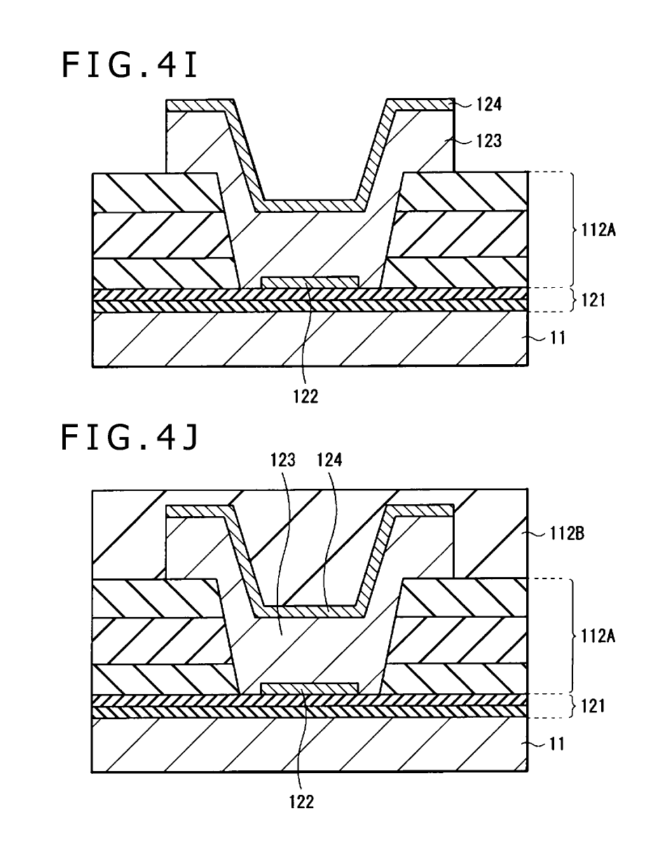

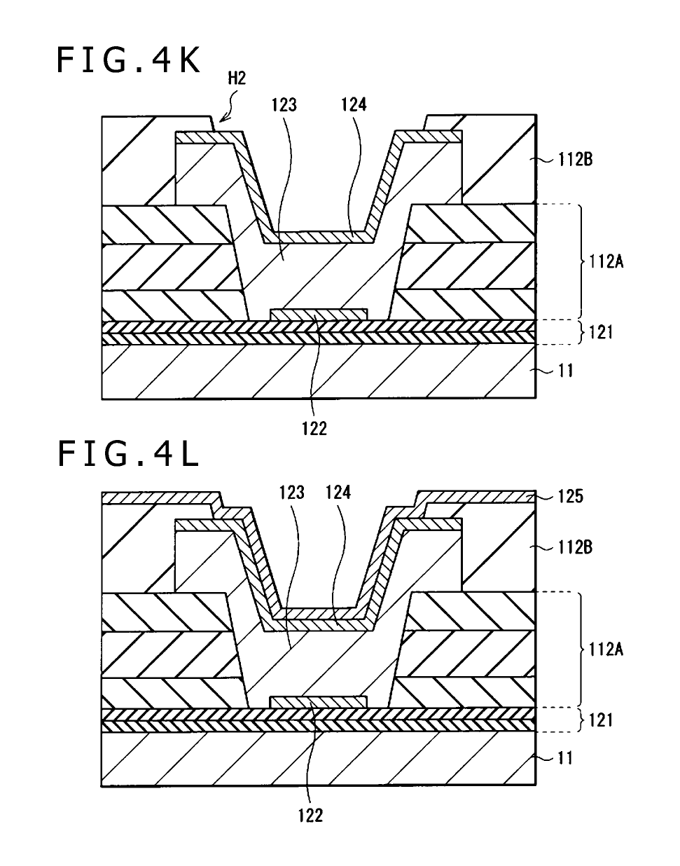

The radiation image pickup device 1 as described above, for example, can be manufactured as follows. That is to say, firstly, the sensor substrate 10 is manufactured. For example, the photodiode 111A and the transistor 111B are formed on the substrate 11 made of a glass by utilizing the known thin film process. Although in the radiation image pickup device 1 of the first embodiment, at least a part of the photodiode 111A and the transistor 111B is collectively formed in the same process, in this case, a method of forming the photodiode 111A will now be described in detail. FIGS. 4A to 4L are respectively cross sectional views showing the method of forming the photodiode 111A in the order of processes.

Firstly, as shown in FIG. 4A, an SiN layer 121a and an SiO₂ layer 121b are deposited in this order on the substrate 11 by, for example, utilizing a Chemical Vapor Deposition (CVD) method, thereby forming the gate insulating film 121. An amorphous silicon (α-Si) layer 122A is deposited on the gate insulating film 121 thus formed by, for example, utilizing the CVD method.

Next, as shown in FIG. 4B, a dehydrogenation annealing treatment is carried out at a temperature of, for example, 400 to 450° C. After that, as shown in FIG. 4C, a laser beam L, for example, having a wavelength of 308 nm is irradiated by, for example, carrying out an Excimer Laser Annealing (ELA) treatment, thereby modifying the α-Si layer 122A into the poly silicon layer. As a result, the poly silicon layer 122B (p-Si) is formed on the gate insulating film 121.

Subsequently, as shown in FIG. 4D, for example, boron (B) ions are implanted into the p-Si layer 122B thus formed by, for example, carrying out an ion implantation process. As a result, the p-type semiconductor layer 122 becoming the p⁺-type region is formed on the gate insulating film 121. After that, as shown in FIG. 4E, the p-type semiconductor layer 122 is patterned by, for example, utilizing a photolithography process.

Next, as shown in FIG. 4F, an SiO₂ layer 112a1, an SiN layer 112a2, and an SiO₂ layer 112a3 are disposed in this order over the entire surface of the substrate 11 on which the p-type semiconductor layer 122 has been formed by, for example, utilizing the CVD method. As a result, the first interlayer insulating film 112A is formed.

Subsequently, as shown in FIG. 4G, the contact hole H1 is formed in an area, of the first interlayer insulating film 112A, which faces the p-type semiconductor layer 122 by, for example, utilizing the photolithography process. In this case, for example, the three layers of the SiO₂ layer 112a1, the SiN layer 112a2, and the SiO₂ layer 112a3 in the p-type semiconductor layer 122 are selectively etched away in one (one stage of) etching process such as a dry etching process.

Next, as shown in FIG. 4H, the i-type semiconductor layer 123 and the n-type semiconductor layer 124 are disposed in this order on the first interlayer insulating film 112A by, for example, utilizing the CVD method so as to be filled in the contact hole H1. As a result, the subduction is caused in the i-type semiconductor layer 123 and the n-type semiconductor layer 124 owing to a difference in height of the contact hole H1.

Subsequently, as shown in FIG. 4I, each of the i-type semiconductor layer 123 and the n-type semiconductor layer 124 thus formed is patterned into a predetermined shape by, for example, utilizing the photolithography process. It is noted that the SiO₂ layer 112a3 in the first interlayer insulating film 112A functions as an etching stopper layer during the patterning.

Next, as shown in FIG. 4J, the second interlayer insulating film 112B is formed over the entire surface of the substrate 11 by, for example, utilizing the CVD method.

Subsequently, as shown in FIG. 4K, the contact hole H2 is formed in an area, of the second interlayer insulating film 112B, which faces the n-type semiconductor layer 124 by, for example, utilizing the photolithography process. After that, as shown in FIG. 4L, the upper electrode 125 is deposited over the entire surface of the substrate 11 by, for example, utilizing a sputtering method. In this case, the subduction is caused in the upper electrode 125 as well owing to a difference in height of each of the contact holes H1 and H2. The photodiode 111A shown in FIG. 1 is completed in the manner as described above.

After completion of the formation of the photodiode 111A and the transistor 111B, the protective film 129 is deposited by, for example, utilizing the CVD method so as to cover both of the photodiode 111A and the transistor 111B, thereby making it possible to manufacture the sensor substrate 10. After that, after the resin material described above, for example, has been applied and formed on the sensor substrate 10 by, for example, utilizing a spin coating method, the resin material thus formed is fired, thereby forming the highly planarizing film 20. Finally, the scintillator plate 30 specially prepared is stuck to the sensor substrate 10 through the highly planarizing film 20 (the peripheral area of the pixel portion 12 is adhered by using the sealing material, or either the circumference of the pixel portion 12 or the panel entire surface is pressed and fixed). As a result, the radiation image pickup device 1 shown in FIG. 1 is completed.

### [Operation and Effects]

An operation and effects of the radiation image pickup device 1 of the first embodiment will now be described with reference to FIGS. 1 to 3, and FIGS. 5 and 6. When the radiation which has been irradiated from a radiation (for example, an X-ray) irradiation source (not shown) to be transmitted through a subject (a body to be detected) is made incident to the radiation image pickup device 1, the radiation thus made incident thereto is subjected to the photoelectric conversion after being subjected to the wavelength conversion, and thus an image of the subject is obtained in the form of an electrical signal. Specifically, the radiation which has been made incident to the radiation image pickup device 1 is firstly converted into the light having the wavelength in the sensitivity range (in the visible range in this case) of the photodiode 111A in the scintillator plate 30 (the visible light is emitted from the scintillator plate 30). The visible light which has been emitted from the scintillator plate 30 in such a manner is made incident to the sensor substrate 10 through the highly planarizing film 20.

When in the sensor substrate 10, a predetermined electric potential is applied from a power source wiring (not shown) to one end (for example, the upper electrode 125) of the photodiode 111A, the light made incident from the side of the upper electrode 125 is converted into the signal electric charges having a quantity of electric charges corresponding to the quantity of received light (that light is subjected to the photoelectric conversion). The signal electric charges generated in the photoelectric conversion are taken out in the form of a photo current from the other end (for example, the p-type semiconductor layer 122) side of the photodiode 111A.

Specifically, the electric charges generated through the photoelectric conversion in the photodiode 111A are collected in the accumulation node N, read out in the form of a current from the accumulation node N, and are supplied to the gate terminal of the transistor Tr2 (the read transistor). The transistor Tr2 outputs the signal voltage corresponding to the signal electric charges thus read out. The signal outputted from the transistor Tr2 is outputted (read out) to corresponding one of the vertical signal lines 18 at the time when the transistor Tr3 is turned ON in response to the row scanning signal Vread. The signals outputted to the respective vertical signal lines 18 are outputted to the horizontal selecting portion 14 through the respective vertical signal lines 18 every pixel column.

In the radiation image pickup device 1 of the first embodiment, the photodiode 111A is formed so as to be filled in each of the contact holes H1 and H2 which are formed in the first interlayer insulating film 112A and the second interlayer insulating film 112B, respectively. Therefore, the dent 10a is provided in the surface of the sensor substrate 10 (which has the uneven shape).

### Comparative Example

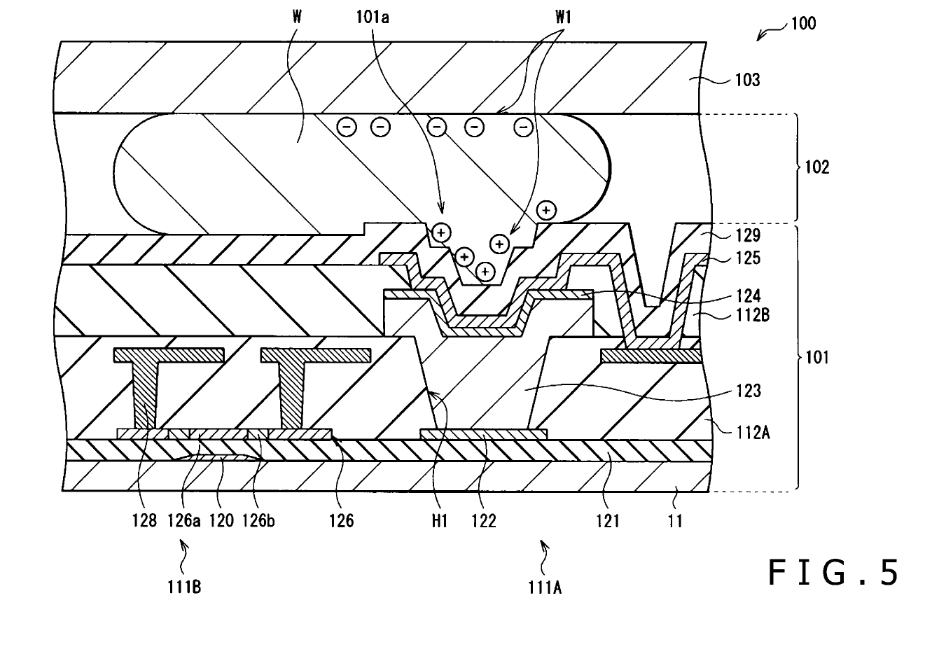

Here, FIG. 5 shows a partial cross-sectional structure in a radiation image pickup device (a radiation image pickup device 100) according to a comparative example for the first embodiment. In the radiation image pickup device 100 of the comparative example as well, a scintillator 103 is disposed in a non-contact state on a sensor substrate 101 having the same lamination structure as that in the first embodiment. A dent 101a is formed on a surface of the sensor substrate 101 so as to correspond to a portion of formation of the photodiode 111A. However, in the radiation image pickup device 100 of the comparative example, a scintillator plate 103 is superposed on the sensor substrate 101 having such a uneven surface. Therefore, a gap portion defined between the sensor substrate 101 and the scintillator plate 103 becomes an atmospheric layer 102 containing therein water vapor.

For this reason, in the radiation image pickup device 100, the dew condensation is generated in the atmospheric layer 102, and a waterdrop W generated by the dew condensation is easy to accumulate in the dent 101a of the sensor substrate 101. The dent 101a, as described above, is provided in the area facing the photodiode 111A. Thus, when the waterdrop W is accumulated in the dent 01a, ion components contained in the water through the electrolysis, for example, are coupled to the upper electrode 125 to cause an increase in a dark current. Such an increase in the dark current, for example, causes the reduction in the brightness in the acquired image. In addition, since the waterdrop W is easy to generate in a local portion of the pixel portion 12, such a dark current is increased in the local portion, and as a result, ununiformity is generated in the brightness. That is to say, an image quantity of the acquired image is deteriorated.

On the other hand, in the radiation image pickup device 1 of the first embodiment, the highly planarizing film 20 having the non-ionic property is provided between the scintillator plate 30 and the sensor substrate 10. As a result, even when the dew condensation, as described above, is generated between the scintillator plate 30 and the sensor substrate 10, the ions causing the coupling to the upper electrode 125 are prevented from being generated. For this reason, the increase in the dark current as described above is suppressed, thereby suppressing the reduction in the brightness in the acquired image (or the generation of the ununiformity of the brightness).

As has been described, in the radiation image pickup device 1 of the first embodiment, the highly planarizing film 20 having the non-ionic property is provided between the scintillator plate 30 and the sensor substrate 10, whereby even when the dew condensation is generated, it is possible to suppress the increase of the dark current owing to the generation of the dew condensation. Accordingly it is possible to suppress the deterioration of the image quality owing to the dew condensation.

In addition thereto, the highly planarizing film 20, for example, is made of a material, such as a silicon resin, which is excellent in the flatness as well as in the non-ionic property, whereby the dent 10a can be removed away and thus the surface side of the sensor substrate 10 can be planarized. For this reason, it is possible to suppress the waterdrop W generated by the dew condensation from being accumulated in the local area, and thus it is possible to more effectively suppress the generation of the ununiformity of the brightness.

Next, a description will be given with respect to radiation image pickup devices according to Modified Changes (Modified Changes 1 to 4) of the first embodiment. It is noted that in each of the radiation image pickup devices according to Modified Changes 1 to 4 of the first embodiment, the same constituent elements as those in the radiation image pickup device 1 of the first embodiment are designated by the same reference numerals or symbols, and a description thereof is suitably omitted for the sake of simplicity.

### 2. Modified Change 1

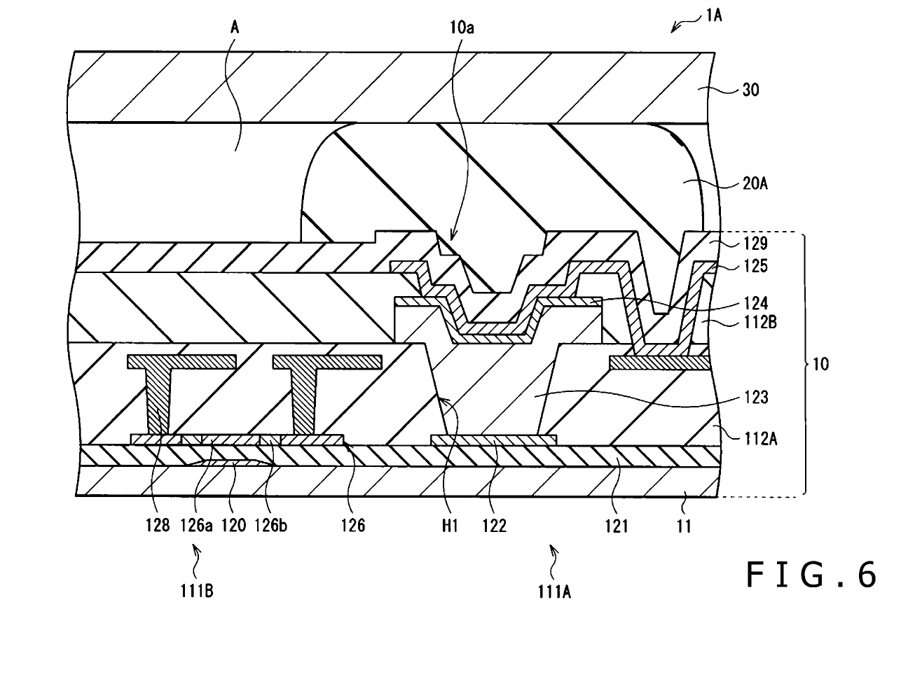

FIG. 6 shows a partial cross-sectional structure of a radiation image pickup device (a radiation image pickup device 1A) according to Modified Change 1 of the first embodiment. In the radiation image pickup device 1A, the scintillator plate 30 is disposed on the sensor substrate 10 similarly to the case of the radiation image pickup device 1 of the first embodiment described above. In addition, a non-ionic layer 20A is provided between the sensor substrate 10 and the scintillator plate 30. In the radiation image pickup device 1A of Modified Change 1, however, the non-ionic layer 20A is selectively provided only in the area facing the dent 10a on the sensor substrate 10, and any area other than the area facing the dent 10a on the sensor substrate 10 becomes an air layer A.

In such a manner, all it takes is that the non-ionic layer 20A is formed so as to be filled in at least the dent 10a on the sensor substrate 10. Thus, even when the waterdrop is generated by the dew condensation, it is possible to avoid the waterdrop from entering the dent 10a facing the photodiode 111A, and it is also possible to suppress the increase in the dark current due to the coupling between the ion components and the upper electrode 125 as described above. Therefore, it is possible to obtain the same effects as those in the first embodiment. However, the process is easier in the case where the highly planarizing layer 20 is formed over the entire surface of the sensor substrate 10 than in the case where the non-ionic layer 20A is formed only in the selective area as with Modified Change 1.

### 3. Modified Change 2

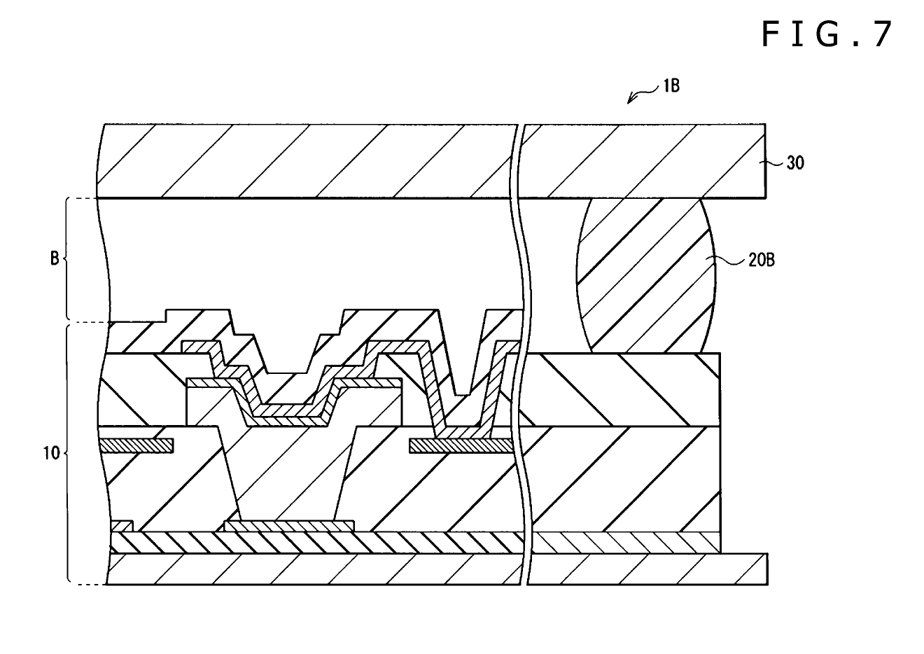

FIG. 7 shows a partial cross-sectional structure of a radiation image pickup device (a radiation image pickup device 1B) according to Modified Change 2 of the first embodiment. In the radiation image pickup device 1B, the scintillator plate 30 is disposed on the sensor substrate 10 similarly to the case of the radiation image pickup device 1 of the first embodiment described above. However, in Modified Change 2, an air layer B (not containing therein water vapor) as a non-ionic layer is provided, and a moistureproof layer 20B is provided between the sensor substrate 10 and the scintillator plate 30. The moistureproof layer 20B, for example, is provided in a peripheral area of the sensor substrate 10 and the scintillator plate 30, and is adapted to suppress the penetration of the water vapor into the air layer B. It is noted that the moistureproof layer 20B may also function as a sealing layer.

In such a manner, the structure may also be adopted such that the provision of the moistureproof layer 20B prevents the moisture (water vapor) from penetrating into the space defined between the sensor substrate 10 and the scintillator plate 30. As a result, the generation of the dew condensation itself in the air layer B is suppressed, thereby making it possible to suppress the increase in the dark current due to the coupling as described above. Therefore, it is possible to obtain the effects comparable to those in the first embodiment described above. In addition, such disposition of the moistureproof layer 20B enables only the air layer 20B to be provided between the sensor substrate 10 and the scintillator plate 30. Thus, this structure is more preferable than that in the first embodiment described above from a viewpoint of a refractive index because it is possible to lighten an optical loss.

It is noted that a hydroscopic layer composed of a desiccant agent or the like may also be provided instead of providing such a moistureproof layer 20B. The provision of the hydroscopic layer can lighten the influence as described above exerted on the photodiode 111A by absorbing the waterdrop even when the dew condensation is generated.

### 4. Modified Change 3

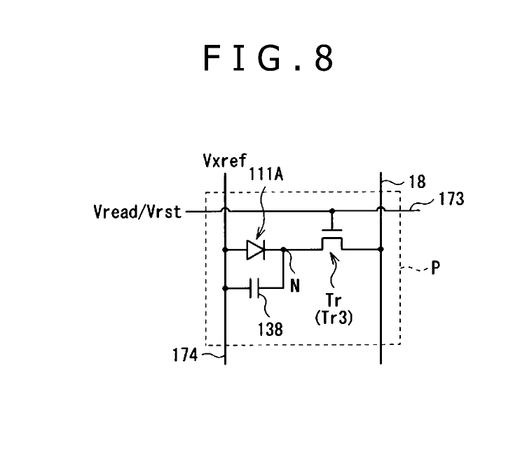

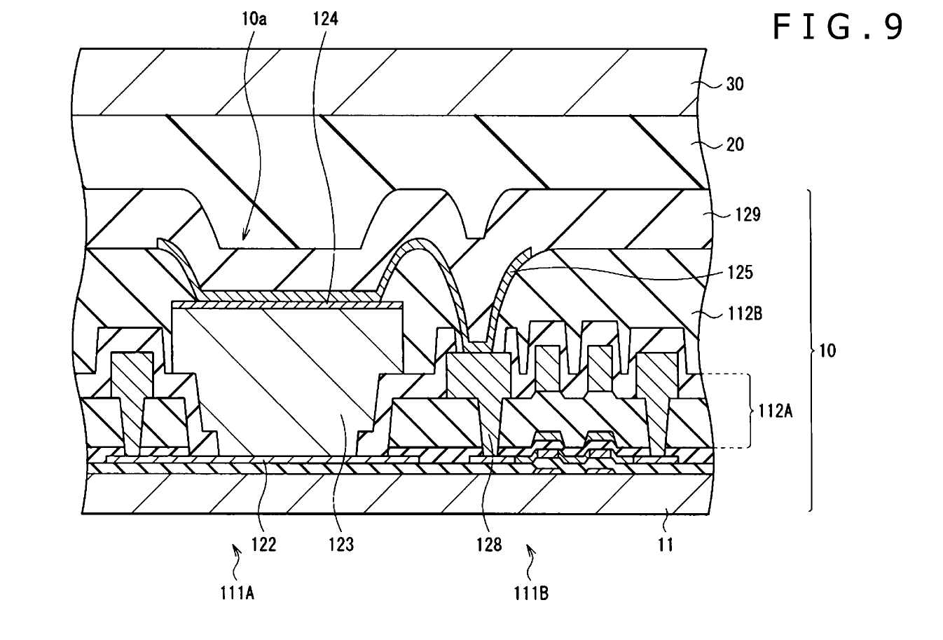

Although in the radiation image pickup device 1 of the first embodiment, the description has been given with respect to the case where the pixel circuit 12a (refer to FIG. 3) complying with the active drive system is used as the pixel circuit provided every pixel P, the pixel circuit provided in the sensor substrate 10 may also be a pixel circuit complying with a passive drive system as shown in FIG. 8. In Modified Change 3, the unit pixel P is configured so as to include a photodiode 111A, a capacitance component 138, and a transistor Tr (corresponding to the transistor Tr3 for read). The transistor Tr is connected between the accumulation node N and the vertical signal line 18. Thus, the transistor Tr is turned ON in response to the row scanning signal Vread, thereby outputting the signal electric charges accumulated in the accumulation node N based on a quantity of received light in the photodiode 111A to the vertical signal line 18A. It is noted that the transistor Tr (the transistor Tr3) corresponds to the transistor 111B in each of the radiation image pickup device 1 of the first embodiment described above, and the radiation image pickup devices 1A and 1B of Modified Changes 1 and 2. In addition, in the case of the passive drive system in Modified Change 3, for example, in a partial cross-sectional structure as shown in FIG. 9, the upper electrode 125 functions as the electrode for taking out the signal (serves as the accumulation node N as well), and is electrically connected to the TFT 111B (the wiring layer 128). As has been described, the pixel drive system is by no means limited to the active drive system described in the radiation image pickup device 1 of the first embodiment, but may also be the passive drive system like Modified Change 3.

### 5. Modified Change 4

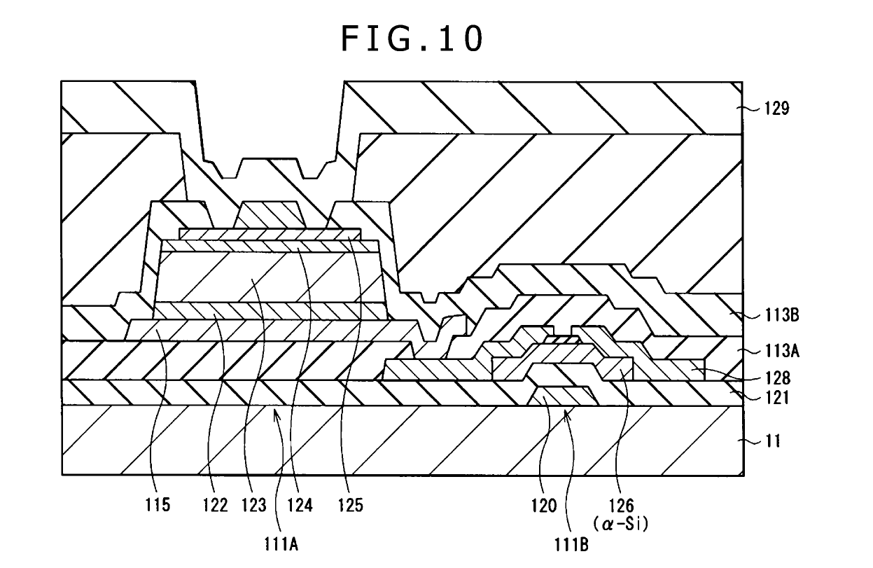

Although in the radiation image pickup device 1 of the first embodiment, polysilicon is used in the p-type semiconductor layer 122 of the photodiode 111A, the p-type semiconductor layer 122 may also be made of amorphous silicon (all of the PIN layers may also be amorphous silicon). It is noted that in this case, as shown in FIG. 10, the p-type semiconductor layer 122 is provided on a first interlayer insulating film 113A (made of SiN) through a lower electrode 115 (made of Mo/Al/Mo). The lower electrode 115 functions as the electrode for taking out the signal, and is connected to the wiring layer 128 (source/drain electrode) of the transistor 111B through a contact hole formed in the first interlayer insulating film 113A. In Modified Change 4, the semiconductor layer 126 of the transistor 111B is also made of amorphous silicon. When amorphous silicon is used in (the n-type semiconductor layer as well as) the p-type semiconductor layer in such a way, it is only necessary to specially provide a metallic electrode (metallic wiring).

Although the first embodiment of the present disclosure has been described so far, the contents of the radiation image pickup device of the present disclosure are by no means limited to the first embodiment described above, and thus can be variously changed. For example, although the structure in which the photodiode 111A and the transistor 111B are disposed in parallel relation to each other in the sensor substrate 10 is exemplified in the first embodiment and Modified Changes 1 to 4 thereof, the present disclosure is by no means limited to such a structure. For example, a structure may also be adopted such that the photodiode 111A and the transistor 111B are laminated in this order on the substrate 11.

In addition, although in the radiation image pickup device 1 of the first embodiment, the non-ionic layer in the present disclosure is described by exemplifying either the highly planarizing film made of the silicon resin, or the air layer, the non-ionic layer is by no means limited thereto. That is to say, all it takes is that a layer having some sort of quality of material which prevents the ions from being generated by the electrolysis is provided.

Moreover, the wavelength converting material used in the scintillator layer 22 is by no means limited to any of the materials described above, and thus other various kinds of phosphor materials can be used.

In addition thereto, although in the radiation image pickup device 1 of the first embodiment, the photodiode 111A adopts the structure in which the p-type semiconductor layer 122, the i-type semiconductor layer 123, and the n-type semiconductor layer 124 are laminated in this order from the substrate 11 side, alternatively, the n-type semiconductor layer 124, the i-type semiconductor layer 123, and the p-type semiconductor layer 122 may also be laminated in this order from the substrate 11 side.

In addition, the radiation image pickup device 1 of the first embodiment needs not to include all of the constituent elements described in the first embodiment. Contrary to this, the radiation image pickup device 1 of the first embodiment may also include any other suitable layer.

### 6. Second Embodiment

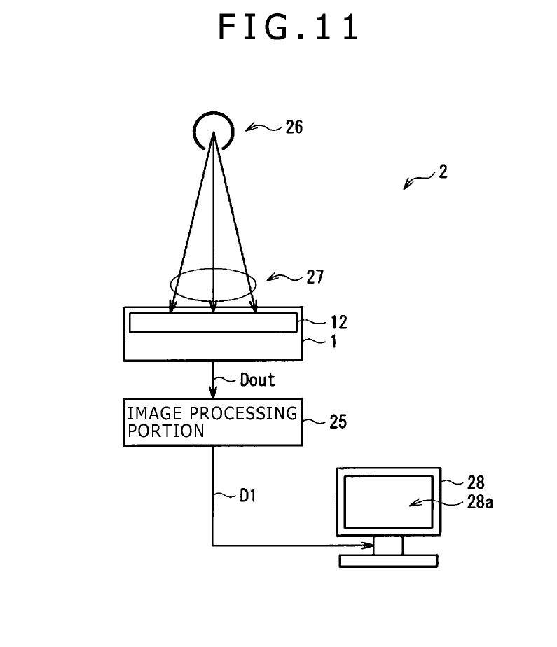

Any of the radiation image pickup devices described in the first embodiment and Modified Changes 1 to 4 thereof can be applied to a radiation image pickup display system 2 shown in FIG. 11. FIG. 11 is a schematic block diagram showing a configuration of the radiation image pickup display system 2 according to a second embodiment of the present disclosure. In this case, the radiation image pickup display system 2, for example, includes the radiation image pickup device 1 according to the first embodiment of the present disclosure. Also, the radiation image pickup display system 2 includes an image processing portion 25 and a display device 28 in addition to the radiation image pickup device 1. With such a configuration, the radiation image pickup display system 2 acquires image data Dout on a subject 27 based on a radiation irradiated from a radiation source 26 to the subject 27, and outputs the image data Dout thus acquired to the image processing portion 25. The image processing portion 25 subjects the image data Dout inputted thereto to predetermined image processing, and outputs the image data (display data D1) obtained through the predetermined image processing to the display device 28. The display device 28 includes a monitor screen 28a, and displays an image based on the display data D1 inputted thereto from the image processing portion 25 on the monitor screen 28a.

In the radiation image pickup display system 2, the radiation image pickup device 1 can acquire the image of the subject 27 in the form of the electrical signal in such a manner. Therefore, the electrical signal thus acquired is transmitted to the display device 28, thereby making it possible to carry out the image display. That is to say, the image of the subject 27 can be observed without using the radiation photograph film, and the radiation image pickup display system 2 can respond to the moving image display as well as the moving image photographing.

It is noted that although the radiation image pickup display system 2 includes the radiation image pickup device 1 according to the first embodiment of the present disclosure, the radiation image pickup display system 2 can also include any of the radiation image pickup devices according to Modified Changes 1 to 4 of the first embodiment instead of including the radiation image pickup device 1 of the first embodiment.

It is noted that the radiation image pickup device and the radiation image pickup display system of the present disclosure may have constitutions as will be described in the following paragraphs (1) to (14).

(1) A radiation image pickup device including: a sensor substrate including a photoelectric conversion element; a non-ionic layer provided on at least a part on the sensor substrate; and a wavelength converting member provided on the non-ionic layer, and converting a wavelength of a radiation into a wavelength in a sensitivity range of the photoelectric conversion element.

(2) The radiation image pickup device described in the paragraph (1), in which the sensor substrate is covered with an insulating protective film, and the non-ionic layer is provided on the insulating protective film.

(3) The radiation image pickup device described in the paragraph (1) or (2), in which a surface, on a light incidence side, of the sensor substrate has a uneven shape, and the non-ionic layer is provided so as to be filled in a recessed portion of the uneven shape.

(4) The radiation image pickup device described in the paragraph (3), in which the non-ionic layer has a uneven surface following the uneven shape on the sensor substrate side, and has a flat surface on the wavelength converting material side.

(5) The radiation image pickup device described in any one of the paragraphs (1) to (4), in which the non-ionic layer is made of a silicon resin, an acrylic resin or a parylene resin.

(6) The radiation image pickup device described in any one of the paragraphs (1) to (5), in which the non-ionic layer is made of the silicon resin.

(7) The radiation image pickup device described in any one of the paragraphs (1) to (6), in which the wavelength converting member has a flat plate-like shape, and is non-adherent to the non-ion layer.

(8) The radiation image pickup device described in any one of the paragraphs (1) to (7), in which a moistureproof layer for suppressing penetration of moisture from an outside is provided between the sensor substrate and the wavelength converting member, and the radiation image pickup device further includes an air layer as the non-ionic layer.

(9) The radiation image pickup device described in any one of the paragraphs (1) to (8), in which a hygroscopic layer is provided between the sensor substrate and the wavelength converting member, and the radiation image pickup device further includes an air layer as the non-ionic layer.

(10) The radiation image pickup device described in any one of the paragraphs (1) to (9), in which the photoelectric conversion element is a PIN diode.

(11) The radiation image pickup device described in any one of the paragraphs (1) to (10), in which in the sensor substrate, the photoelectric conversion element and a transistor are disposed in parallel relation to each other.

(12) The radiation image pickup device described in any one of the paragraphs (1) to (11), in which the transistor includes a semiconductor layer made of any one of polycrystalline silicon, microcrystalline silicon, amorphous silicon, and an oxide semiconductor.

(13) The radiation image pickup device described in any one of the paragraphs (1) to (12), in which the semiconductor layer is made of low-temperature polycrystalline silicon.

(14) A radiation image pickup display system including: an image pickup device acquiring an image based on a radiation; and a display device displaying thereon the image acquired from the image pickup device, the image pickup device including: a sensor substrate including a photoelectric conversion element; a non-ionic layer provided on a part on the sensor substrate; and a wavelength converting member provided on the non-ionic layer, and converting a wavelength of a radiation into a wavelength in a sensitivity range of the photoelectric conversion element.

The present application contains subject matter related to that disclosed in Japanese Priority Patent Application JP 2011-119918 filed in the Japan Patent Office on May 30, 2011, the entire content of which is hereby incorporated by reference.

It should be understood by those skilled in the art that various modifications, combinations, sub-combinations and alterations may occur depending on design requirements and other factor in so far as they are within the scope of the appended claims or the equivalents thereof.

What is claimed is:

1. A radiation image pickup device, comprising:
a sensor substrate including a photoelectric conversion element;
a non-ionic layer provided on a part on said sensor substrate; and
a wavelength converting member provided on said non-ionic layer, and converting a wavelength of a radiation into a wavelength in a sensitivity range of said photoelectric conversion element.

2. The radiation image pickup device according to claim 1, wherein said sensor substrate is covered with an insulating protective film; and
said non-ionic layer is provided on said insulating protective film.

3. The radiation image pickup device according to claim 1, wherein a surface, on a light incidence side, of said sensor substrate has a uneven shape; and
said non-ionic layer is provided so as to be filled in a recessed portion of the uneven shape.

4. The radiation image pickup device according to claim 3, wherein said non-ionic layer has a uneven surface following the uneven shape on said sensor substrate side, and has a flat surface on the wavelength converting material side.

5. The radiation image pickup device according to claim 4, wherein said non-ionic layer is made of a silicon resin, an acrylic resin or a parylene resin.

6. The radiation image pickup device according to claim 5, wherein said non-ionic layer is made of the silicon resin.

7. The radiation image pickup device according to claim 1, wherein said wavelength converting member has a flat plate-like shape, and is non-adherent to said non-ion layer.

8. The radiation image pickup device according to claim 1, wherein a moistureproof layer suppressing penetration of moisture from an outside is provided between said sensor substrate and said wavelength converting member; and
said radiation image pickup device further comprises an air layer as said non-ionic layer.

9. The radiation image pickup device according to claim 1, wherein a hygroscopic layer is provided between said sensor substrate and said wavelength converting member; and
said radiation image pickup device further comprises an air layer as said non-ionic layer.

10. The radiation image pickup device according to claim 1, wherein said photoelectric conversion element is a PIN diode, PIN standing for positive intrinsic negative.

11. The radiation image pickup device according to claim 10, wherein in said sensor substrate, said photoelectric conversion element and a transistor are disposed in parallel relation to each other.

12. The radiation image pickup device according to claim 11, wherein said transistor includes a semiconductor layer made of any one of polycrystalline silicon, microcrystalline silicon, amorphous silicon, and an oxide semiconductor.

13. The radiation image pickup device according to claim 12, wherein said semiconductor layer is made of low-temperature polycrystalline silicon.

14. A radiation image pickup display system, comprising:
an image pickup device acquiring an image based on a radiation; and
a display device displaying thereon the image acquired from said image pickup device,
said image pickup device including
a sensor substrate including a photoelectric conversion element;
a non-ionic layer provided on a part on said sensor substrate; and
a wavelength converting member provided on said non-ionic layer, and converting a wavelength of a radiation into a wavelength in a sensitivity range of said photoelectric conversion element.
